(19) United States
(12) Patent Application Publication
(10) Pub. No.: US 2020/0250897 A1
(43) Pub. Date: Aug. 6, 2020

(54) INTELLIGENT PROGNOSTICS AND HEALTH MANAGEMENT SYSTEM AND METHOD

(71) Applicant: Marketech International Corp., Taipei City (TW)

(72) Inventors: Chien-Ming Martin Wei, Taipei City (TW); Guo-Yan Fan, Hsinchu City (TW); Wei-Huan Hu, Hsinchu City (TW)

(21) Appl. No.: 16/263,728

(22) Filed: Jan. 31, 2019

(51) Int. Cl. G07C 3/14; G06N 3/08; G06N 20/00

(52) U.S. Cl. CPC G07C 3/14; G01M 99/005; G06N 20/00; G06N 3/08

(57) ABSTRACT

The present invention relates to an intelligent prognostics and health management system and method, the system comprises an analytic engine service manager module, an intelligent prognostics and health management object analytics tree module, a machine learning library module, and a file system module. After the analytic engine service manager module defines an analytics tree according to components of a to-be-monitored machine, the intelligent prognostics and health management object analytics tree module is controlled by the analytic engine service manager module to obtain monitoring data of the to-be-monitored machine. One of default reference hypothesis model sets with the highest similarity of the system is selected for modeling, thereby a model selection and disposition are quickly complete.

### FIELD OF THE INVENTION

The present invention relates to a predictive maintenance system and method, and more particularly to an intelligent prognostics and health management system and method for establishing an object analytics tree for machine management and selecting a prognostics model by adaptive method according to new machine characteristics.

### BACKGROUND OF THE INVENTION

In order to ensure the stability of production process of a production machine and increase the utilization rate, the manufacturing industry must conduct strict quality monitoring of the operational status of the production machine.

In order to meet quality requirements of the operational status of the production machine, the prior art has strict monitoring and observation for critical process parameters. The so-called “critical parameters” refer to the factors most relevant to equipment failures. In practice, these factors are monitored as an important indicator for equipment predictive maintenance. In order to improve the accuracy of prediction, a number of publicly available techniques have proposed various improvements. For example, U.S. patent Ser. No. 16/001,520 discloses a selection method of leading auxiliary parameters and the predictive maintenance method of equipment in combination with critical parameters and leading associated parameters. After filtering the data collected by the sensor and classifying the data into a critical parameter set and other feature parameter sets, identifying the one from the feature parameter sets affecting the critical parameters at the earliest time in advance as the leading associated parameters, and further utilizing the critical parameter set and the leading associated parameters to establish an equipment predictive maintenance model that effectively enhances the early warning capability.

In addition, the prior art needs to construct a separate feature database for each machine for constructing a prognostics model. In this way, when complex and heterogeneous machines are introduced into the machine prognostics and health management system, in addition to increasing the complexity of the system, a large amount of resources and costs are consumed.

Therefore, there is a need to develop an intelligent prognostics and health management system and method to solve the maintenance and management problems of prognostics and health management system confronted with when introducing a large number of production machines of the same type or different types.

### SUMMARY OF THE INVENTION

The main objective of the present invention is to solve the shortcomings of the prior art that the prognostics and the health management system are difficult to maintain and manage when introducing a large number of production machines of the same type or different types.

In order to achieve the above objective, the present invention provides an intelligent prognostics and health management system, comprising: an analytic engine service manager (AESM) module; an intelligent prognostics and health management object analytics tree (SPHM-OAT) module, a machine learning library module, and a file system module, wherein the intelligent prognostics and health management object analytics tree module is connected to the analytic engine service manager module, and the intelligent prognostics and health management object analytics tree module comprises a plurality of analytics trees, and each of the analytics trees comprises a plurality of analytics tree nodes to obtain monitoring data of a machine to be monitored; the machine learning library module is connected to the intelligent prognostics and health management object analytics tree module to provide at least one algorithm for the intelligent prognostics and health management object analytics tree module; and the file system module is connected to the intelligent prognostics and health management object analytics tree module to provide a default reference hypothesis model and feature sample data corresponding to the default reference hypothesis model.

The present invention also provides an intelligent prognostics and health management method comprising:

a step of establishment of new tree and similarity analysis: defining at least one analytics tree according to components of a to-be-monitored machine, wherein the analytics tree comprises a plurality of analytics tree nodes (SPHM-object) and a storage indicator built-in with default reference hypothesis models and corresponding feature data of each of the analytics tree nodes to obtain monitoring data of the machine to be monitored from a file system according to the storage indicator, and performing a similarity analysis between the monitoring data and feature sample data of the default reference hypothesis models; and a step of modeling performed in following step S1 or step S2, wherein:

step S1: modeling the monitoring data based on the default reference hypothesis model with highest similarity selected from the default reference hypothesis models when the similarity analysis exceeds a threshold value;

step S2: modeling the monitoring data through an external hypothesis model is introduced through an expansion module when the similarity analysis does not exceed the threshold value.

Therefore, the effects that the present invention can achieve compared to the prior art are:

1. Reflecting the tree structure of the prognostics and health management system of the machine to be monitored through the analytics trees, and transmitting the information of the monitoring points of the end component equipment upwards from the analytics tree nodes, by quantifying the monitoring status of each of the analytics tree nodes, step-by-step analyzing the health status of each of the analytics tree nodes from bottom to top in a recursive manner, and finally gathering to the top to form the analytics tree describing the health status of a complete single specific machine equipment, and composing the intelligent prognostics and health management object analytics tree module from the plurality of analytics trees. The system architecture of the present invention can be generally applied to any system machine equipment, which not only simplifies the introduction process of the prognostics and health management system, but also utilizes various computing resources efficiently to quickly complete the hypothesis model and disposition.

2. When a new machine is introduced into the intelligent prognostics and health management system of the present invention, the analytic engine service manager module will perform the similarity analysis according to the feature data of the new machine. According to the plurality of default reference hypothesis model set indicators in the intelligent prognostics and health management object analytics tree module, the appropriate hypothesis model is selected from the file system module by an adaptive method to construct a prognostics model to save the system management and hypothesis model disposition time.

3. If the similarity between the monitoring data of the introduced new machine and the feature set to which the default reference hypothesis models belong in the system of the present invention is lower than a specified threshold value, the external hypothesis model can be imported by the expansion module to establish a hypothesis model in the intelligent prognostics and health management object analytics tree module, thereby maintaining flexibility and expandability in the modeling process.

### BRIEF DESCRIPTION OF THE DRAWINGS

FIG. 1A is a schematic diagram of an architecture of an intelligent prognostics and health management system according to one embodiment of the present invention;

FIG. 1B is a schematic diagram of a workflow hierarchy of an intelligent prognostics and health management object analytics tree module according to one embodiment of the present invention;

FIG. 2 is a schematic diagram of an operation flow of the intelligent prognostics and health management system according to one embodiment of the present invention; and

FIG. 3 is a schematic diagram of an ecological hierarchy according to one embodiment of the present invention.

### DETAILED DESCRIPTION OF THE PREFERRED EMBODIMENTS

The detailed description and technical contents of the present invention will be described in conjunction with the drawings as follows:

The present invention provides a design pattern and method of a system architecture for establishing or updating an intelligent prognostics and health management object analytics tree module for equipment health management. The system and method of the present invention are generally applied to various types of machine equipment such as wind power generator, coal pulverizer, metalorganic chemical vapor deposition system (MOCVD), plasma enhanced chemical vapor deposition system (PECVD), etc.

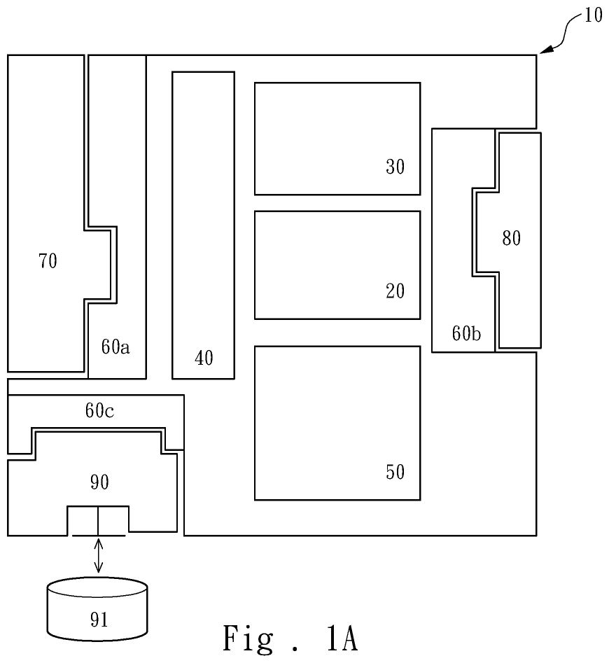

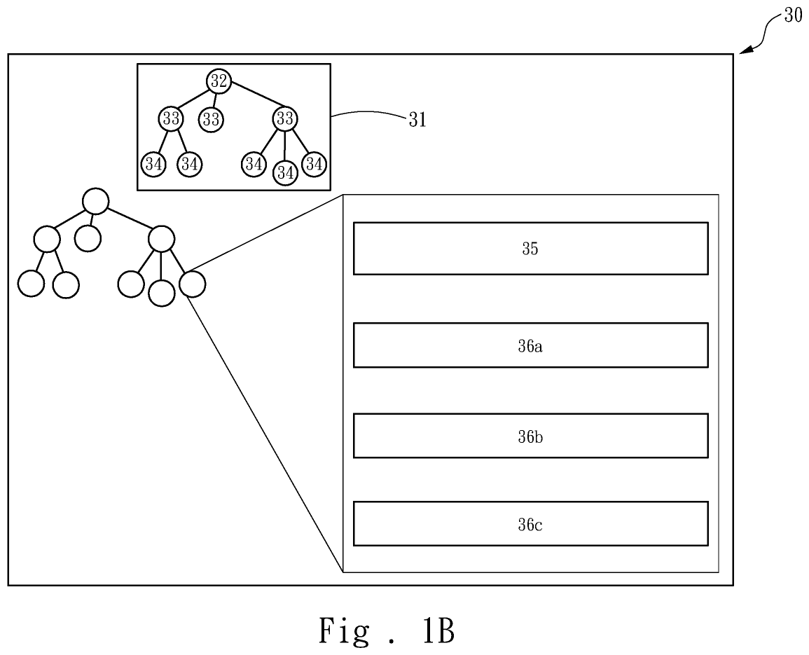

FIG. 1A is a schematic diagram of an architecture of an intelligent prognostics and health management system 10 according to one embodiment of the present invention, which mainly comprises an analytic engine service manager module 20, an intelligent prognostics and health management object analytics tree module 30, a machine learning library module 40, and a file system module 50. In order to make the application of the system of the present invention with higher expandability, the intelligent prognostics and health management system 10 of the present invention further includes an expansion module that connects the intelligent prognostics and health management object analytics tree module 30. The expansion module includes a first exchangeable application programming interface 60a, a second exchangeable application programming interface 60b, and an exchangeable driver interface 60c. The first exchangeable application programming interface 60a is connected an external machine learning module 70, the second exchangeable application programming interface 60b is connected an external reference model module 80, and the exchangeable driver interface 60c is connected an external data collection driving device (EDCD) 90 to obtain an original data from an external database 91 disposed in an equipment of a machine to be monitored.

The analytic engine service manager module 20 is a core of the intelligent prognostics and health management system 10 of the present invention, and the analytic engine service manager module 20 is able to control status of each component in the intelligent prognostics and health management object analytics tree module 30.

Referring to FIG. 1B, the intelligent prognostics and health management object analytics tree module 30 is connected to the analytic engine service manager module 20. Further, the intelligent prognostics and health management object analytics tree module 30 comprises a plurality of analytics trees 31, and each of the analytics trees 31 comprises a plurality of analytics tree nodes 33, 34. Each of the plurality of analytics tree nodes 33 and 34 respectively corresponds to a critical parameter and a plurality of associated parameters. The data sources of the critical parameters and the plurality of associated parameters are information obtained by a sensor or aggregated by critical parameters and other associated parameters of their child nodes. Each of the plurality of analytics tree nodes 33, 34 is connected to an object control table, and the object control tables store operational results of the corresponding analytics tree nodes 33 and 34 in an analysis process, and the object control tables have effects of regular backup and restoration. In this way, if a disaster event occurs during the analysis process, the intelligent prognostics and health management system 10 is able to quickly perform a reversion operation through the object control tables to obtain status of the analytics tree nodes from the last checkpoint, and then analyzes from sibling nodes to parent nodes recursively through the hierarchical integration operational analysis. The analysis is continued from bottom to top until the analysis of the highest level analytics tree node (i.e. root) is complete. Regarding the above-mentioned sibling nodes and parent nodes, for example, for one of the plurality of analytics tree nodes 34, the other plurality of analytics tree nodes 34 are defined as the sibling nodes, and the plurality of analytics tree nodes 33 are defined as the parent nodes; however, for the analytics tree nodes 34, the analytics tree nodes 33 may be defined as its child node.

Accordingly, the intelligent prognostics and health management system 10 of the present invention is able to timely reflect health status of the analytics tree nodes 33, 34 through the analytics tree nodes 33, 34 on the premise that monitoring data sources are correct and the selection of the critical parameters and the associated parameters are also correct, in order to be well prepared for early warning and health management.

The intelligent prognostics and health management object analytics tree module 30 is also responsible for workflow management of the analytics tree nodes 33, 34 in addition to managing the analytics trees 31 corresponding complex types of machines. The so-called “workflow” is managed by a mapping table 35, which includes a data preprocessing layer 36a, a data hypothesis layer 36b, and a data ensemble learning layer 36c formed by stacking. Levels, sequences and actual work content of the workflow are able to be adjusted according to requirements, and is not limited to the above content.

The mapping table 35 is operated by a table driven mechanism, according to a preset working method from the mapping table 35, selecting at least one suitable algorithm from the machine learning library module 40 connected to the intelligent prognostics and health management object analytics tree module 30, and the at least one algorithm is provided the workflows such as the data preprocessing layer 36a, the data hypothesis layer 36b, or the data ensemble learning layer 36c to use. For example, the algorithm applicable to the data preprocessing layer 36a includes algorithms with feature selection capabilities such as a feature selection algorithm or a feature extraction algorithm; an algorithm applicable to the data hypothesis layer 36b includes a regression algorithm, an autoregressive integrated moving average model (ARIMA) algorithm, a relative strength index (RSI) algorithm, or algorithms with prognostic capabilities; and a working method of the data ensemble learning layer 36c is to perform voting by constructing a set of a plurality of hypothesis models specified by the mapping table 35, or hierarchical integrated operations specified in accordance with the current analytics tree 31. In addition, the analytic engine service manager module 20 also controls a workflow of each of the analytics trees 31 according to the mechanism of the mapping table 35.

The file system module 50 in one embodiment is used for the intelligent prognostics and health management system 10 to write back files and/or save files. The above-mentioned “files”, for example, includes quantitative analysis information of life cycle of the analytics trees 31 in the intelligent prognostics and health management object analytics tree module 30, or feature sample data sets of default reference hypothesis model sets before modeling, or backup data when the system fails in a calculation process, or the reference hypothesis to which each of the plurality of analytics tree nodes 33 and 34 belongs, in order to provide the information required by the intelligent prognostics and health management object analytics tree module 30 when necessary.

If necessary, the intelligent prognostics and health management system 10 of the present invention is able to be expanded by connecting external devices through the expansion module. For example, when existing information of the machine learning library module 40 is insufficient, the external machine learning module 70 is connected by the first exchangeable application programming interface 60a of the expansion module to expand function of the machine learning library module 40; the external reference model module 80 is connected by the second exchangeable application programming interface 60b of the expansion module to expand hypothesis model of the mapping table 35 of the intelligent prognostics and health management object analytics tree module 30 and the machine learning library module 40 participates in the selection and disposition of an external hypothesis model in a manual mode; the external data collection driving device 90 is connected to the exchangeable driver interface 60c of the expansion module, the external data collection driving device 90 is connected to the external database 91, and therefore, the original data of the external database 91 stored in the equipment of the machine to be monitored is obtained through the external data collection driving device 90.

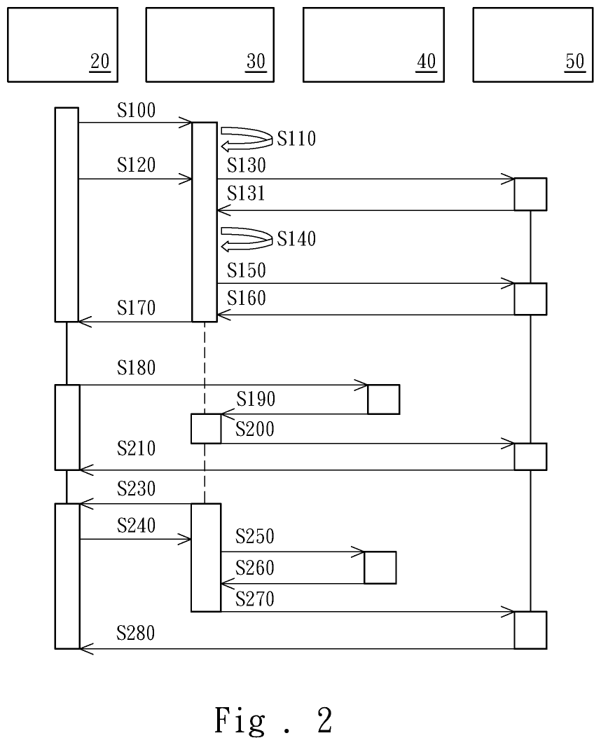

Please refer to FIG. 2 for a schematic diagram of an operation flow of the intelligent prognostics and health management system 10 according to one embodiment of the present invention, which mainly comprises a step of establishment of new tree and similarity analysis, and a step of modeling.

Regarding the step of establishment of new tree and similarity analysis, firstly, a new tree is established in a manual mode, and relevant tree establishing information is transmitted to the intelligent prognostics and health management object analytics tree module 30 through the analytic engine service manager module 20 to establish a new analytics tree. Secondly, the external data collection driving device 90 further collects data required by the analytics tree, and the data comprises first n original data of monitoring points of end components of the machine to be monitored (S110). The “manual mode” here refers to the classification of first-level equipment, second-level equipment and third-level equipment by engineering personnel according to the upper, lower, first and subsequent affiliation between the components in the to-be-monitored machine. Based on the manual mode, the number of levels is determined to define the analytics tree that is exclusive to an ecological hierarchy of the to-be-monitored machine.

Then, the analytic engine service manager module 20 starts the similarity analysis on the original data (S120). Firstly, the file system module 50 is requested through the intelligent prognostics and health management object analytics tree module 30 according to the default reference hypothesis model indicator of each of the analytics tree nodes and a location specified by a storage indicator of corresponding feature data stored in the intelligent prognostics and health management object analytics tree module 30 (S130) and obtain a data matrix of the feature samples for establishing the default reference hypothesis models (S131). And, the intelligent prognostics and health management object analytics tree module 30 checks the similarity between the obtained sample features of the machine to be monitored and the sample features of the default reference model hypothesis provided by the file system module 50 before modeling (S140). When the similarity exceeds a threshold value and is the highest, the hypothesis model is used as a baseline model of hypothesis model, and the workflow selected by the baseline model of hypothesis model is used as a preset basic workflow (S160).

After the analytic engine service manager module 20 receives the workflow associated information transmitted by the intelligent prognostics and health management object analytics tree module 30 (S170), and the analytic engine service manager module 20 selects a required algorithm from the machine learning library module 40 through the mapping table 35 of the intelligent prognostics and health management object analytics tree module 30 to complete automatic modeling setting (S180). Then, the intelligent prognostics and health management object analytics tree module 30 adds the hypothesis model indicators and workflows suitable for the machine to be monitored to the mapping table 35 (S190), and new hypothesis models and feature data are stored in the file system module 50 to complete model transplantation (S200). Finally, the file system module 50 notifies the intelligent prognostics and health management object analytics tree module 30 to update new hypothesis analysis module setting of new machine to be monitored in the mapping table 35, and the file system module 50 notifies the analytic engine service manager module 20 that the transplantation is complete (S210).

If the intelligent prognostics and health management object analytics tree module 30 is unable to find a feature sample with high similarity in the file system module 50, for example, when the similarity indicator value between the first n feature data of the machine to be monitored and the feature data before the modeling of the existing reference model hypothesis set is lower than a specified threshold value, the intelligent prognostics and health management object analytics tree module 30 first notifies the analytic engine service manager module 20 (S230) to prompt engineering personnel to perform an external expansion command. Then, the analytic engine service manager module 20 instructs the intelligent prognostics and health management object analytics tree module 30 to plugin appropriate the reference hypothesis model indicator, feature data set indicator, and corresponding workflow setting to the intelligent prognostics and health management object analytics tree module 30 externally and manually by the engineering personnel through the expansion module (S240). Next, the intelligent prognostics and health management object analytics tree module 30 calls an algorithm required by an external plugin workflow from the machine learning library module 40 (S250) to complete a manual modeling setting (S260), and then an external plugin information and a modeling information are written back by the intelligent prognostics and health management object analytics tree module 30, for example, locations of the external plugin information and the modeling information stored in the file system module 50 are specified by the reference hypothesis model indicator and the feature data set indicator described above (S270), and the analytic engine service manager module 20 is notified that hypothesis model expansion is complete (S280).

The above “similarity” is for finding whether there is a hypothesis model in the default reference hypothesis model sets preset in the system of the present invention suitable for analyzing the to-be-monitored machine. For a specific comparison manner, for example, a distance similarity is to compare the feature sets before the modeling of the hypothesis models preset in the system with the first n original data converted into a same feature space of the machine to be monitored. If the distance between the two features is smaller, the similarity is higher; otherwise, the similarity is lower. Common similarity calculation methods, such as Euclidean distance, Mahalanobis distance, Manhattan distance, Minkowski distance, cosine similarity and so on, is able to be used. Through the above similarity calculation, the appropriate hypothesis model is able to be selected from the default reference hypothesis model sets as a baseline prognostics model of the to-be-monitored machine.

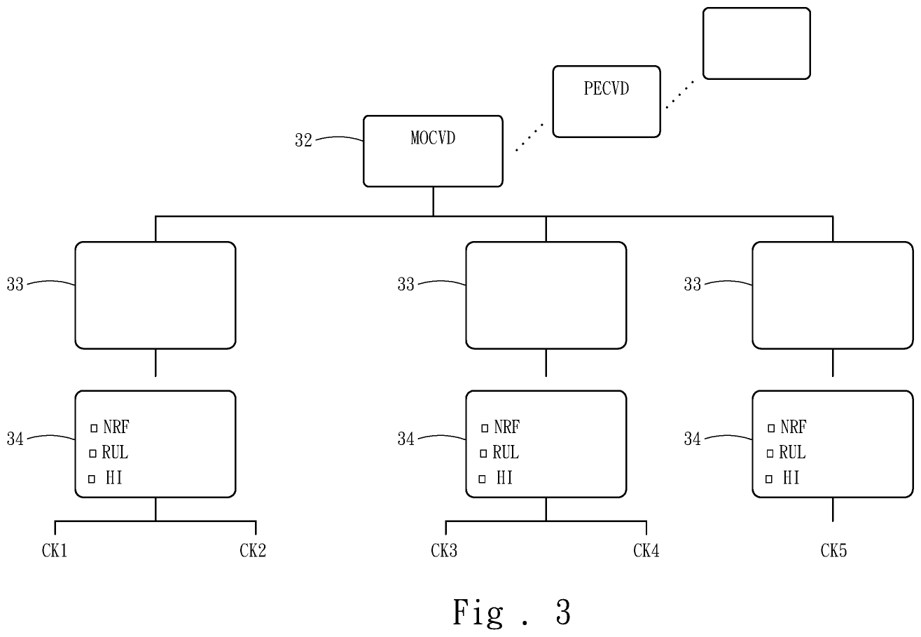

Hereinafter, the system of the present invention is applied to monitor a metalorganic chemical vapor deposition (MOCVD) machine as an example for explanation. Please refer to FIG. 3 in conjunction with FIG. 1A, FIG. 1B and FIG. 2.

In one embodiment, the relationship between all MOCVD equipment components and one analytics tree node is first defined according to a hierarchical structure. In FIG. 3, each of the analytics tree nodes 33, 34 corresponds to a critical parameter (CP) and a plurality of associated parameters (AP), and one of SPHM health indicators (SPHM-HI) is able to reflect the health status of each of the analytics tree nodes of the analytics tree in a timely manner to be well prepared for early warning and health management.

The SPHM health indicators (SPHM-HI) are expandable. Examples of basic items of the health indicators (SPHM-HI) include next N-run fail (NRF) indicator, remaining useful life (RUL) indicator for equipment critical components, general health indicator (HI), and other similarly associated health indicators. Since the functions, types, actual quantification and analysis methods are well known to those ordinarily skilled in the art, they will not be described here.

Next, the analytic engine service manager module 20 branches downward from an analytics tree node 32, and defines the intelligent prognostics and health management object analytics tree module 30 exclusively for the MOCVD machine ecological hierarchy according to the upper, lower, first and subsequent affiliation between the components in the MOCVD equipments. Wherein, a root representing the MOCVD machine (i.e. the analytics tree node 32), the root is connected to one or several child nodes (i.e. second level equipment, the analytics tree nodes 33), and then from the child nodes continue to link to one or several new child nodes (i.e. third level equipment, the analytics tree nodes 34). In this way, the connection is repeated just like tree roots slowly growing downward, thereby forming the complete intelligent prognostics and health management object analytics tree module 30 (S100). It should be explained that the three-level setting of the first-level equipment, the second-level equipment, and the third-level equipment is described here, however, in other embodiments, the number of levels is able to be increased or decreased according to actual conditions and requirements, and the present invention is not limited thereto.

Continued with FIGS. 1A, 1B and 2, data is collected from terminal nodes (i.e. the analytics tree nodes 33, 34) after the establishment of the intelligent prognostics and health management object analytics tree module 30, (S110), and the data is gathered in the external database 91. The terminal nodes (i.e. the analytics tree nodes 33, 34) represent the monitoring status of the end equipment components of the MOCVD machine, and the data comes from monitoring points CK1, CK2, CK3, CK4, and CK5.

Then, the intelligent prognostics and health management object analytics tree module 30 obtains the original data of the end monitoring points from the external database 91 and starts the similarity analysis (S120): Firstly, the intelligent prognostics and health management object analytics tree module 30 finds the default reference hypothesis model sets according to the mapping table 35; and the intelligent prognostics and health management object analytics tree module 30 performs similarity comparison according to the data feature samples before the modeling of each of the default reference hypothesis models (S130 and S131) and the first n original data collected by the MOCVD end monitoring points after being converted into feature pattern (S140). When the similarity is higher than a specified threshold value, the default reference hypothesis set with the highest similarity is selected and sets as the baseline prognostics model hypothesis (S150).

Then, the workflow of the baseline prognostics model hypothesis is specified, and associated algorithms are introduced from the machine learning library module 40 into the intelligent prognostics and health management system 10 (S160, S170, and S180), and the reference hypothesis model set indicator and the feature data set indicator with the highest similarity are added to the mapping table 35 of the intelligent prognostics and health management object analytics tree module 30, so that modeling setting exclusively for the MOCVD machine is able to be complete (S190). Finally, the baseline prognostics model transplantation is completed and stored in the file system module 50 (S200) and the analytic engine service manager module 20 is notified that an automatic model transplantation is complete (S210).

However, when the similarity is lower than a specified threshold value, the intelligent prognostics and health management object analytics tree module 30 notifies the analytic engine service manager module 20 that similar feature data and the corresponding hypothesis model are not found (S230). Then, the analytic engine service manager module 20 is connected to the external reference model module 80 through the second exchangeable application programming interface 60b of the expansion module to manually introduce a hypothesis model suitable for the MOCVD machine from the external reference model module 80, and adds new indicators to the mapping table 35 of the intelligent prognostics and health management object analytics tree module 30 (S240), and simultaneously calls algorithms required for modeling from the machine learning library module 40 (S250). After the modeling is complete, the modeling is written to the file system module 50, and the analytic engine service manager module 20 is notified that manual model expansion is complete (S280).

Finally, as shown in FIG. 3, when the intelligent prognostics and health management system 10 of the present invention starts prognostics analysis for the MOCVD machine, the intelligent prognostics and health management object analytics tree module 30 quantitatively analyzes the health status of each of the nodes from the bottom to up in a recursive manner, and the analysis is the hierarchical integration operation based on the workflow specified by each of the nodes in the mapping table 35, and the characteristics of the critical parameters (CP) and the associated parameters (AP). Finally, the health status of each of the nodes quantitatively converges to the top (root). The same method is able to be applied to prognostics analysis of other machines such as PECVD.

The “tree structure” emphasized by the present invention is a data concept in computer science. According to the embodiments of the present invention, the intelligent prognostics and health management object analytics tree module 30 has the following characteristics: (1) a tree has only one highest level node and is referred to as the “root” 32, which is regarded as the current status of the top level of a to-be-monitored machine; (2) each of the nodes derives more than one child node, and if a quantity of the child nodes derived from each of the nodes is within two, the tree is called a binary tree; (3) the node at the very end of the bottom level is called “leaf” or called “terminal node” (such as the analytics tree nodes 33, 34), and is regarded as the end components of the to-be-monitored machine including the monitoring points CK1, CK2, CK3, CK4, CK5, which are the data sources of the end components; and (4) a large number of sub-trees that are not connected are called “forest”, the forest is regarded as a plurality of to-be-monitored machines that are simultaneously managed. As known from the above description, the “tree structure” is a hierarchical structure. A new machine to be monitored starts from the “root” and is connected to one or several child nodes (secondary level equipment, such as the analytics tree nodes 33), and then from the child nodes continue to link to one or several new child nodes (third level equipment, such as the analytics tree nodes 34). In this way, the connection is repeating for growing slowly like tree roots to form a complete analytics tree (OAT). The advantage of the tree structure is that the hierarchy is well-defined and organized, and the upper, lower, first and subsequent affiliation between the components in the machine to be monitored is clearly indicated. Therefore, it is suitable for prognostics and health management of complex types of equipment.

In this way, the present invention not only reduces the management complexity and labor cost after introducing complex and heterogeneous machines into the machine prognostics and health management system, but also maintains the system with a certain precision to further coordinate with the automatic model selection mechanism, so that the introduction process of prognostics and health management system is simplified, and computing resources are more effective to quickly complete prognostics model selection and disposition.

What is claimed is:

1. An intelligent prognostics and health management system, comprising:
an analytic engine service manager module;
an intelligent prognostics and health management object analytics tree module, connected to the analytic engine service manager module, the intelligent prognostics and health management object analytics tree module comprising a plurality of analytics trees, and each of the plurality of analytics trees comprising a plurality of analytics tree nodes to obtain monitoring data of a machine to be monitored;
a machine learning library module, connected to the intelligent prognostics and health management object analytics tree module to provide at least one algorithm for the intelligent prognostics and health management object analytics tree module; and
a file system module, connected to the intelligent prognostics and health management object analytics tree module to provide a default reference hypothesis model and feature sample data corresponding to the default reference hypothesis model.

2. The intelligent prognostics and health management system of claim 1, the intelligent prognostics and health management system further comprising an expansion module connected to the intelligent prognostics and health management object analytics tree module, the expansion module comprising a first exchangeable application programming interface, a second exchangeable application programming interface, and an exchangeable driver interface, wherein the first exchangeable application programming interface is capable of being connected to an external machine learning module, the second exchangeable application programming interface is capable of being connected to an external reference model module, and the exchangeable driver interface is capable of being connected to an external data collection driving device to obtain an original data of a database disposed in the machine to be monitored.

3. The intelligent prognostics and health management system of claim 1, wherein the intelligent prognostics and health management object analytics tree module comprises a mapping table.

4. The intelligent prognostics and health management system of claim 3, wherein the analytic engine service manager module controls a workflow of the plurality of analytics tree nodes based on the mapping table in the intelligent prognostics and health management object analytics tree module.

5. The intelligent prognostics and health management system of claim 1, wherein each of the plurality of analytics tree nodes corresponds to a critical parameter (CP) and a plurality of associated parameters (AP).

6. An intelligent prognostics and health management method, comprising:
a step of establishment of new tree and similarity analysis:
defining at least one analytics tree according to components of a machine to be monitored, wherein the analytics tree comprises a plurality of analytics tree nodes and a storage indicator built-in with default reference hypothesis models and feature data corresponding to the default reference hypothesis models to obtain monitoring data of the machine to be monitored from a file system, and performing the similarity analysis between the monitoring data and the feature data corresponding to the default reference hypothesis models; and
a step of modeling performed in following step S1 or step S2, wherein:
step S1: modeling the monitoring data based on the default reference hypothesis models with highest similarity selected from the default reference hypothesis models when the similarity analysis exceeds a threshold value; and
step S2: modeling the monitoring data through an external hypothesis model introduced through an expansion module when the similarity analysis does not exceed the threshold value.

7. The intelligent prognostics and health management method of claim 6, wherein the similarity analysis is performed by converting first n original data of the machine to be monitored into same feature space as feature sets before the modeling of the default reference hypothesis models and then comparing distance similarity.

8. The intelligent prognostics and health management method of claim 6, in the step of establishment of new tree and similarity analysis, an analytic engine service manager module defining the analytics tree in an intelligent prognostics and health management object analytics tree module according to the components of the machine to be monitored.

9. The intelligent prognostics and health management method of claim 8, in the step of establishment of new tree and similarity analysis, the intelligent prognostics and health management object analytics tree module performing the similarity analysis between the monitoring data and the feature data corresponding to the default reference hypothesis models.

10. The intelligent prognostics and health management method of claim 8, wherein the intelligent prognostics and health management object analytics tree module comprises a mapping table, and the mapping table selects at least one algorithm from a machine learning library module connected to the intelligent prognostics and health management object analytics tree module for the plurality of analytics tree nodes to perform a workflow management.
